(19) United States
(12) Patent Application Publication
(10) Pub. No.: US 2026/0038236 A1
(43) Pub. Date: Feb. 5, 2026

(54) METHODS AND SYSTEMS FOR CLOUD SHADOW BIPARTITE MATCHING

(71) Applicant: Maxar Intelligence Inc., Westminster, CO (US)

(72) Inventors: Stephen Anthony, Westminster, CO (US); Brett Bader, Westminster, CO (US); Michael Aschenbeck, Westminster, CO (US); Charles Danforth, Westminster, CO (US)

(21) Appl. No.: 18/792,281

(22) Filed: Aug. 1, 2024

(51) Int. Cl. G06V 10/74; G06V 10/26; G06V 10/75; G06V 10/762; G06V 10/764; G06V 10/86; G06V 20/13; G06V 20/17

(52) U.S. Cl. CPC G06V 10/761; G06V 10/26; G06V 10/751; G06V 10/7635; G06V 10/764; G06V 10/86; G06V 20/13; G06V 20/17

(57) ABSTRACT

Methods and systems for performing cloud and shadow matching for a high-altitude image of a portion of earth, the method including performing segmentation of clouds and shadows in the high-altitude image, determining, on an image of the portion of earth, determining a cloud-to-shadow vector, performing maximum bipartite matching to associate one shadow to at least one cloud, grouping at least one cloud and at least one shadow into at least one cluster, and estimating false positives and false negatives in the cloud and shadow segmentation.

### BACKGROUND

Examples of the disclosure generally relate to processing of digital imagery and, in particular, to the processing of digital geospatial imagery to match corresponding clouds and shadows to generated geospatial images.

### SUMMARY

In one aspect of the present disclosure, a method for performing cloud and shadow matching for a high-altitude image of a portion of earth, the method including performing segmentation of clouds and shadows in the image, determining a cloud-to-shadow vector, performing maximum bipartite matching to associate one shadow to at least one cloud, grouping at least one cloud and at least one shadow into at least one cluster, and estimating false positives and false negatives in the cloud and shadow segmentation.

In various examples, performing maximum bipartite matching includes establishing a plurality of possible shadow locations for the at least one cloud, determining an adjacency matrix for quality scores of at least one cloud-shadow pair and a plurality of distances along the cloud-to-shadow vector, determining one or more desired cloud-shadow-distance tuples, determining a 3D cloud altitude for each cloud in the cloud-shadow pairs using a distance along the cloud-to-shadow vector, satellite azimuth and elevation, and sun azimuth and elevation, and determining a distribution of the 3D cloud altitudes. For example, determining the adjacency matrix for quality scores of the at least one cloud-shadow pair and the plurality of distances along the cloud-to-shadow vector includes initializing a 3D matrix having dimensions including a number of cloud segments, a number of shadow segments, and a number of distances along the cloud-to-shadow vector, for each pair of cloud segment and shadow segment, determining a shape and area of the at least one cloud, for each distance of the plurality of distances along the cloud-to-shadow vector, extrapolating the determined shape and area of the at least one cloud to the distance along the cloud-to-shadow vector to generate an extrapolated cloud segment, comparing the extrapolated cloud segment to the shadow segment, and determining a quality score for the extrapolated cloud segment, shadow segment, and distance along the cloud-to-shadow vector tuple based on the comparison. In an example, comparing the extrapolated cloud segment to the shadow segment by performing an intersection over union process. In another example, comparing the extrapolated cloud to the shadow segment includes determining a percentage overlap between the area of the extrapolated cloud and the pixels in the shadow segment. In a further example, the determined quality score is proportional to the percentage overlap.

In various examples, grouping the at least one cloud and the at least one shadow into a cluster includes creating a sparse symmetric adjacency matrix, running a Depth-First Search on the adjacency matrix, and calculating a 3D cloud altitude of every cloud cluster based on the running of the Depth-First Search. For example, creating the sparse symmetric adjacency matrix includes creating a square matrix of zeros with each dimension being a sum of a number of cloud segments (N), a number of shadow segments (M), and a unit representing a collection of all segments, wherein indices 1 to N represent the cloud segments and indices N+1 to N+M represent the shadow segments, and for each cloud-shadow correspondence from maximum bipartite matching having cloud index i and shadow index j, replacing an entry at row i and column j in the sparse symmetric adjacency matrix with the quality score of the cloud-shadow correspondence. For example, running the Depth-First Search includes running the Depth-First Search on a graph represented by the sparse symmetric adjacency matrix, and identifying each list of connected indices as a cluster of clouds and a cluster of shadows.

In other examples, grouping the at least one cloud and the at least one shadow into the cluster includes defining interconnected shadows and clouds, and wherein one of a single cloud is connected to a single shadow, a single cloud is connected to a plurality of shadows, a single shadow is connected a plurality of clouds, and a plurality of clouds are connected to a plurality of shadows. In a further example, calculating the 3D cloud altitude of every cloud cluster includes, for each cloud cluster, extrapolating an area and shape of the cloud cluster for a plurality of distances along the cloud-to-shadow vector to generate an extrapolated cloud segment, for each distance of the plurality of distances, calculating the quality score of the extrapolated cloud cluster and shadow segment, choosing a distance with a desired quality score, and calculating the altitude of the cloud cluster based on a number of factors including satellite azimuth and elevation, and sun azimuth and elevation.

In further examples, estimating false positives and false negatives in the cloud and shadow segmentation includes identifying possible false positive cloud pixels, identifying possible false positive shadow pixels, identifying possible false negative cloud pixels, and identifying possible false negative shadow pixels. For example, identifying possible false positive cloud pixels includes classifying unmatched and unclustered cloud segments as possible false positives, and for clustered cloud segments, identifying one or more expected distances of a match along the cloud-to-shadow vector, reversing the cloud-to-shadow vector, extrapolating the area and shape of the shadow cluster at an expected distance along the reversed cloud-to-shadow vector, and classifying unmarked cloud pixels that do not match the extrapolated shadow pixels as possible false positive cloud pixels. In other examples, identifying possible false positive shadow pixels includes classifying unmatched and unclustered shadow segments as possible false positives, and for clustered shadow segments, identifying one or more expected distances of a match along the cloud-to-shadow vector, extrapolating the area and shape of the cloud cluster at the distance along the cloud-to-shadow vector, and classifying unmarked shadow pixels that do not match the extrapolated cloud pixels as possible false positive shadow pixels.

In further examples, identifying possible false negative cloud pixels includes identifying each shadow segment, reversing the cloud-to-shadow vector, identifying one or more expected distances of a match along the reversed cloud-to-shadow vector, extrapolating the area and shape of the shadow cluster at an expected distance along the reversed cloud-to-shadow vector, and classifying cloud pixels that do not match the extrapolated shadow pixels as possible false negative cloud pixels. In an additional example, identifying possible false negative shadow pixels includes identifying each cloud segment, identifying one or more expected distances of a match along the cloud-to-shadow vector, extrapolating the area and shape of the cloud cluster at the distance along the cloud-to-shadow vector, and classifying shadow pixels that do not match the extrapolated cloud pixels as possible false negative cloud pixels.

In another aspect of the present disclosure, a cloud and shadow matching system for a high-altitude image of a portion of earth, the system including an updatable data repository, a high-altitude image capture device, and a computing device operatively coupled to the updatable data repository and to the image capture device, the computing device including a processor and a memory, the memory storing instructions that, when executed by the processor, perform a set of operations. The set of operations include performing, via the processor, segmentation of clouds and shadows in the image, determining, via the processor, a cloud-to-shadow vector, performing, via the processor, maximum bipartite matching to associate one shadow to at least one cloud, grouping, via the processor, at least one cloud and at least one shadow into at least one cluster, and estimating, via the processor, false positives and false negatives in the cloud and shadow segmentation.

In various examples, the set of operations includes performing maximum bipartite matching by establishing a plurality of possible shadow locations for the at least one cloud, determining an adjacency matrix for quality scores of at least one cloud-shadow pair and a plurality of distances along the cloud-to-shadow vector, determining one or more desired cloud-shadow-distance tuples, determining a 3D cloud altitude for each cloud in the cloud-shadow pairs using a distance along the cloud-to-shadow vector, satellite azimuth and elevation, and sun azimuth and elevation, and determining a distribution of the 3D cloud altitudes. For example, the set of operations includes determining the adjacency matrix for quality scores of the at least one cloud-shadow pair and the plurality of distances along the cloud-to-shadow vector by initializing a 3D matrix having dimensions including a number of cloud segments, a number of shadow segments, and a number of distances along the cloud-to-shadow vector, for each pair of cloud segment and shadow segment, determining a shape and area of the at least one cloud, for each distance of the plurality of distances along the cloud-to-shadow vector, extrapolating the determined shape and area of the at least one cloud to the distance along the cloud-to-shadow vector to generate an extrapolated cloud segment, comparing the extrapolated cloud segment to the shadow segment, and determining a quality score for the extrapolated cloud segment, shadow segment, and distance along the cloud-to-shadow vector tuple based on the comparison. For example, the set of operations includes comparing the extrapolated cloud segment to the shadow segment includes performing an intersection over union process. In another example, the set of operations includes comparing the extrapolated cloud to the shadow segment by determining a percentage overlap between the area of the extrapolated cloud and the pixels in the shadow segment. For example, the determined quality score is proportional to the percentage overlap.

In further examples, the set of operations includes grouping the at least one cloud and the at least one shadow into a cluster by creating a sparse symmetric adjacency matrix, running a Depth-First Search on the adjacency matrix, and calculating a 3D cloud altitude of every cloud cluster based on the running of the Depth-First Search. For example, the set of operations includes creating the sparse symmetric adjacency matrix by creating a square matrix of zeros with each dimension being a sum of a number of cloud segments (N), a number of shadow segments (M), and a unit representing a collection of all segments, wherein indices 1 to N represent the cloud segments and indices N+1 to N+M represent the shadow segments, and for each cloud-shadow correspondence from maximum bipartite matching having cloud index i and shadow index j, replacing an entry at row i and column j in the sparse symmetric adjacency matrix with the quality score of the cloud-shadow correspondence.

In other examples, the set of operations includes running the Depth-First Search by running the Depth-First Search on a graph represented by the sparse symmetric adjacency matrix, and identifying each list of connected indices as a cluster of clouds and a cluster of shadows. In another example, the set of operations includes grouping the at least one cloud and the at least one shadow into the cluster by defining interconnected shadows and clouds, and wherein one of a single cloud is connected to a single shadow, a single cloud is connected to a plurality of shadows, a single shadow is connected a plurality of clouds, and a plurality of clouds are connected to a plurality of shadows. In a further example, the set of operations includes calculating the 3D cloud altitude of every cloud cluster by, for each cloud cluster, extrapolating an area and shape of the cloud cluster for a plurality of distances along the cloud-to-shadow vector to generate an extrapolated cloud segment, for each distance of the plurality of distances, calculating the quality score of the extrapolated cloud cluster and shadow segment, choosing a distance with a desired quality score, and calculating the altitude of the cloud cluster based on a number of factors including satellite azimuth and elevation, and sun azimuth and elevation.

In other examples, the set of operations includes estimating false positives and false negatives in the cloud and shadow segmentation by identifying possible false positive cloud pixels, identifying possible false positive shadow pixels, identifying possible false negative cloud pixels, and identifying possible false negative shadow pixels. In an example, the set of operations includes identifying possible false positive cloud pixels by classifying unmatched and unclustered cloud segments as possible false positives, and for clustered cloud segments, identifying one or more expected distances of a match along the cloud-to-shadow vector, reversing the cloud-to-shadow vector, extrapolating the area and shape of the shadow cluster at an expected distance along the reversed cloud-to-shadow vector, and classifying unmarked cloud pixels that do not match the extrapolated shadow pixels as possible false positive cloud pixels. In yet another example, the set of operations includes identifying possible false positive shadow pixels by classifying unmatched and unclustered shadow segments as possible false positives, and for clustered shadow segments, identifying one or more expected distances of a match along the cloud-to-shadow vector, extrapolating the area and shape of the cloud cluster at the distance along the cloud-to-shadow vector, and classifying unmarked shadow pixels that do not match the extrapolated cloud pixels as possible false positive shadow pixels.

In additional examples, the set of operations includes identifying possible false negative cloud pixels by identifying each shadow segment, reversing the cloud-to-shadow vector, identifying one or more expected distances of a match along the reversed cloud-to- shadow vector, extrapolating the area and shape of the shadow cluster at an expected distance along the reversed cloud-to-shadow vector, and classifying cloud pixels that do not match the extrapolated shadow pixels as possible false negative cloud pixels. For example, the set of operations includes identifying possible false negative shadow pixels by identifying each cloud segment, identifying one or more expected distances of a match along the cloud-to-shadow vector, extrapolating the area and shape of the cloud cluster at the distance along the cloud-to-shadow vector, and classifying shadow pixels that do not match the extrapolated cloud pixels as possible false negative cloud pixels.

In various examples, the high-altitude image includes a satellite image. In other examples, the image capture device includes one of a satellite and a high-altitude aircraft.

The details of one or more techniques are set forth in the accompanying drawings and the description below. Other features, objects, and advantages of these techniques are apparent from the description, drawings, and claims.

### BRIEF DESCRITION OF THE DRAWINGS

FIGS. 1A-1B are illustrations of initial cloud shadow segmentation.

FIG. 2 is an illustration of cloud shadow matching, in accordance with various examples of the disclosure.

FIG. 3 is a cloud matching diagram illustrating a cloud-to-shadow vector, in accordance with various examples of the disclosure.

FIG. 4 is an illustration of maximum bipartite cloud shadow matching.

FIG. 5 is an illustration of cloud matching, in accordance with various examples of the disclosure.

FIG. 6 is an illustration of refining mask results from geometric clues, in accordance with various examples of the disclosure.

FIGS. 7A and 7B are illustrations of cloud shadow segmentation, in accordance with various examples of the disclosure.

FIG. 8 is a flowchart illustrating a method for cloud shadow matching, in accordance with various examples of the disclosure.

FIG. 9 depicts a block diagram of a computing device, according to various aspects.

Before one or more examples of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It is appreciated that the terms “comprising,” “comprises,” and “comprised of”' as used herein comprise the terms “consisting of,” “consists,” and “consists of.”

Whereas the terms “one or more” or “at least one”, such as one or more or at least one member(s) of a group of members, is clear per se, by way of further exemplification, the term encompasses inter alia a reference to any one of said members, or to any two or more of said members, such as, e.g., any ≥3, ≥4, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure. In the following passages, different aspects of the present disclosure are defined in more detail. Each aspect so defined may be combined with any other aspect or aspects unless clearly indicated to the contrary.

Reference throughout this specification to “one example” or “an example” means that a particular feature, structure or characteristic described in connection with the example is included in at least one example of the present disclosure. Thus, appearances of the phrases “in one example” or “in an example” in various places throughout this specification are not necessarily all referring to the same example, but may. Furthermore, the particular features, structures or characteristics may be combined in any suitable manner, as would be apparent to a person skilled in the art from this disclosure, in one or more examples. Furthermore, while some examples described herein include some, but not other features included in other examples, combinations of features of different examples are meant to be within the scope of the disclosure, and form different examples, as would be understood by those in the art. For example, in the appended claims, any of the claimed examples can be used in any combination.

In the present disclosure, reference is made to the accompanying drawings that form a part hereof, and in which are shown by way of illustration only of specific examples in which the present disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims.

### Cloud Shadow Matching

Accurate cloud and shadow masks or segments in Geographic Information System (GIS) imagery are valuable in improving the ability to generate cloud-free and shadow-free mosaics using a limited number of satellite images. Creation of cloud-free mosaics typically requires recognizing and excluding from each component image areas of ground which were not properly imaged due to, e.g., being obstructed by clouds, and such process is typically referred to as cloud-punching. Creation of shadow-free mosaics can employ a similar process (shadow-punching). A combination of cloud-punching and shadow-punching allows creation of cloud-free and shadow-free mosaic images by combining multiple satellite images, each of which has some areas of clouds and/or shadows.

Cloud and shadow data mask layers are developed, e.g., for Analysis Ready Data (ARD). However, these mask layers may be prone to false positive errors and false negative errors. Accordingly, examples of the disclosure include a method and system that matches corresponding clouds and shadows within GIS imagery using, e.g., a combination of graph theory, modified bipartite matching, image processing, and the geometry of the clouds, sun, and the image capture device such as, e.g., a satellite or aircraft. Given a set of previously determined cloud and shadow locations, examples of this disclosure determine which shadows are generated by which clouds, and vice versa. The matches can be used to identify likely errors in the initial cloud and shadow determinations, resulting in more accurate cloud and shadow label masks, which is advantageous in producing high-quality mosaics using a limited number of satellite images.

In general, the cloud data mask layer is more accurate than the shadow data mask layer. Common sources of confusion for shadow detections include forests, marshes, or other areas which are legitimately darker than their surrounding landscape, where confusion can produce either false positives or false negatives. Thick, opaque clouds are generally detected accurately, but, e.g., snow can serve as a source of confusion and thin, wispy clouds may fail to be detected yet interfere with ground observation quality.

Examples of the disclosure improve the quality of the cloud and shadow data mask layers by using cloud-shadow matches to identify cases where cloud and shadow annotations do not agree, suggesting the possibility that either the unmatched element is a false positive and should be omitted or that a new matching element should be created at the appropriate location to eliminate a false negative.

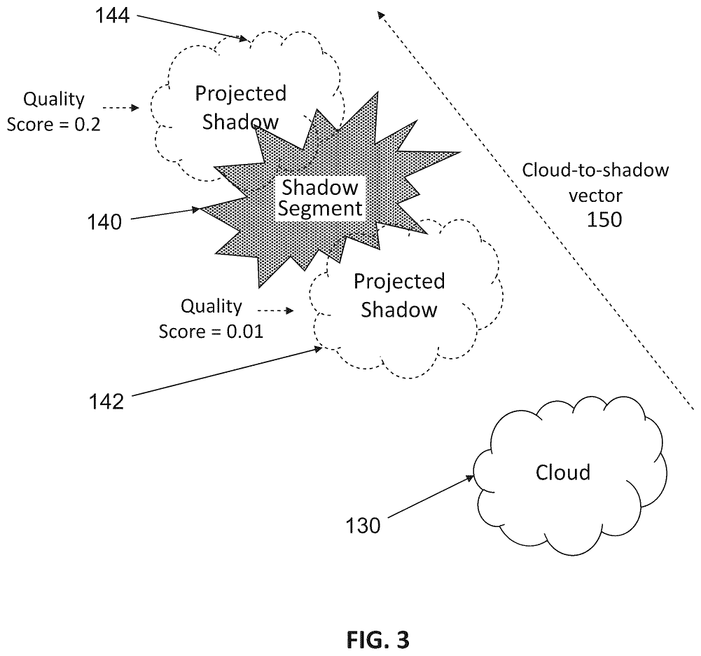

According to various examples, cloud-shadow matching includes a plurality of operations. For example, graph theory adjacency matrices may be relied on to indicate for each cloud which shadow(s) the cloud could potentially match, and the quality of this mapping at each possible distance along the cloud-to-shadow vector, a vector denoting the effective direction a shadow appears in the image relative to its cloud. The direction of the cloud-to-shadow vector may also be referred to as the cloud-to-shadow direction. The cloud-to-shadow direction may be the same for all clouds and their shadows in an image collected from a static viewpoint, but each cloud-to-shadow vector may have a different position which originates at each cloud segment. FIG. 3 below describes a cloud matching diagram illustrating the cloud-to-shadow vector. However, a number of challenges exist such as, e.g., a cloud shadow can be obscured by another cloud, a cloud shadow can be outside the image and cannot be detected, the mapping may not be one-to-one between cloud and shadow because a single cloud may have more than one shadow. Examples of the disclosure may further determine the distribution of cloud heights, and cloud-shadow matches may be determined for all displacements corresponding to all possible cloud heights. An adjacency matrix may be constructed showing the quality scores for mapping each cloud to each shadow. Maximum bipartite matching may be used to discover initial cloud-shadow matches. From the matches which are found, the best matches may be selected, and the corresponding cloud heights determined. From these, the distribution of cloud heights may be computed. Examples of the disclosure may also recalculate the quality of all possible cloud-shadow matches, considering the probability based on the cloud height distribution. In many cases, a cloud may only have a single potential matching shadow, and vice versa. Because one cloud may be associated with multiple shadows and vice versa, examples of the disclosure may cluster clouds and shadows according to match quality and determine the distance along the cloud-to-shadow vector which collectively maximizes the overall quality of the matches between all clouds and all shadows in the cluster.

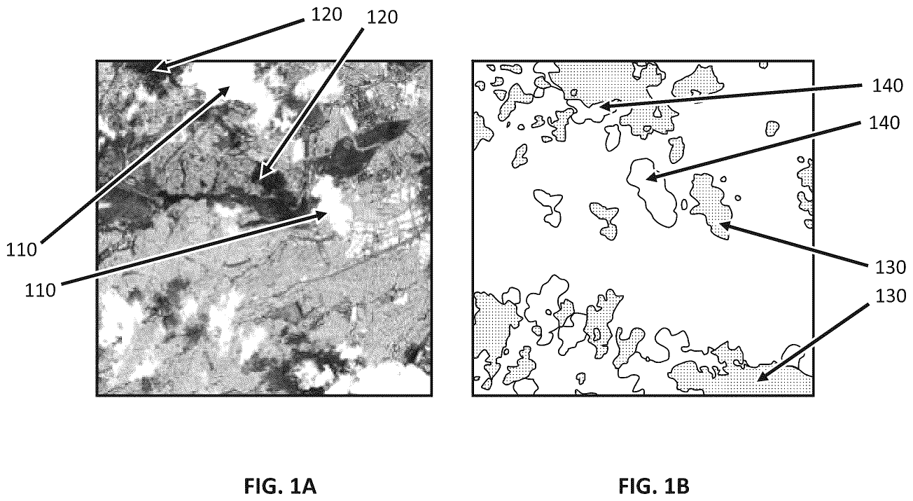

FIGS. 1A-1B are illustrations of initial cloud shadow segmentation. In examples, cloud shadow matching starts with cloud and shadow segmentation. An initial shadow segmentation provided by, e.g., ARD cloud and shadow masks, may be used. This initial shadow segmentation may provide a sufficient starting point to determine shadowed and non-shadowed pixels. FIG. 1A is an image taken from altitude, e.g., via satellite or high-altitude aircraft, that shows clouds 110 and cloud shadows 120. FIG. 1B identifies the cloud segments 130 and the cloud shadow segments 140 from FIG. 1A as obtained via an initial ARD cloud and shadow segmentation. For example, the cloud segments 130 and the shadow segments 140 correspond to clouds such as the clouds 110 and to cloud shadows such as the shadows 120. The collective segments 130 and 140, also referred to herein as masks 130 and 140, can be used as a basis, as further described below, to improve cloud and shadow matching.

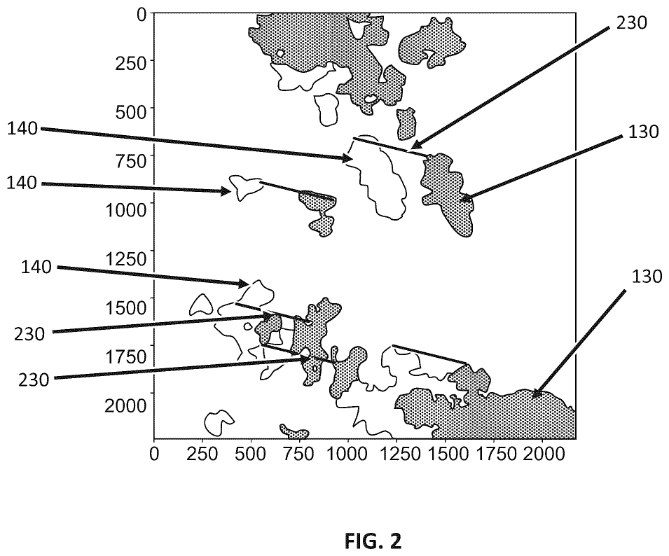

FIG. 2 is an illustration of cloud shadow matching, in accordance with various examples of the disclosure. In FIG. 2, the initial cloud and shadow masks such as, e.g., the clouds and shadow masks or segments 130 and 140 obtained from FIG. 1, may not be sufficiently accurate by, e.g., suggesting that some clouds are present when there are no clouds (false positives), or on the other hand not recognizing existing clouds or cloud shadows (false negatives). Accordingly, in FIG. 2, a number of cloud-to-shadow vectors 230 may be determined to link cloud segments 130 to shadow segments 140 from, e.g., sun position, aircraft or satellite altitude, and the like. In FIG. 2, elements 130 represent the cloud segments as identified from FIGS. 1A and 1B. Elements 140 represent the shadow segments that may correspond to the cloud segments 130. Accordingly, cloud-to-shadow vectors 230 which connect given clouds 130 to their corresponding shadows 140 are illustrated in FIG. 2. As such, cloud and shadow matching may be performed.

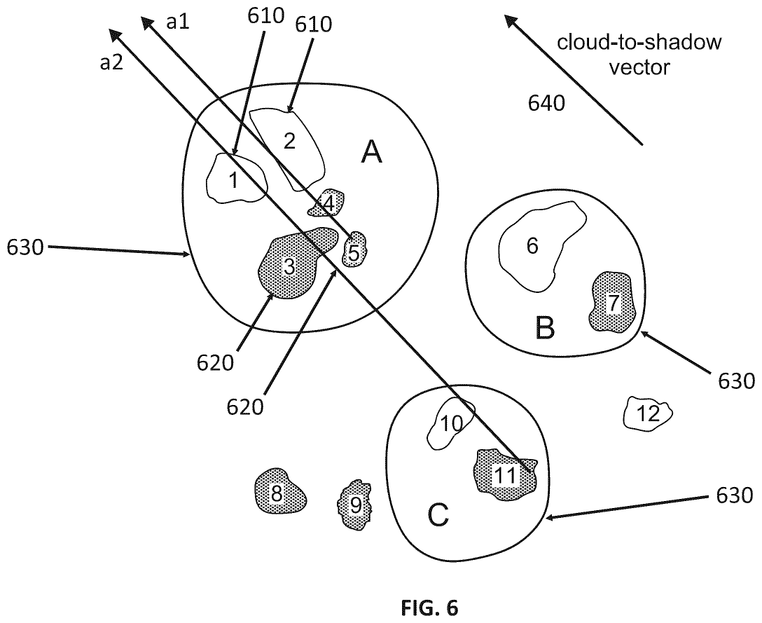

FIG. 3 is a cloud matching diagram illustrating a cloud-to-shadow vector 150, in accordance with various examples of the disclosure. In FIG. 3, a cloud 130 is illustrated, along with possible shadow candidates 142 and 144 along the cloud-to-shadow vector 150. The cloud-to-shadow vector 150 may be determined based on, e.g., positions of the sun and the camera with respect to the cloud 130. FIG. 3 also illustrates shadow segment 140, as identified, e.g., as discussed above with respect to FIG. 2. FIG. 3 also illustrates a quality score for the projected shadow 142 and for the protected shadow 144. For example, when the overlap between the projected shadow 142 and the shadow segment 140 is poor, then the quality score may be low and equal to, e.g., 0.01. A poor overlap is determined when the area of the projected shadow 142 and the area of the shadow segment 140 are poorly matched to each other and show little overlap. FIG. 3 also shows that the overlap between the projected shadow 144 and the shadow segment 140 is higher, showing a better match between the area of the projected shadow 144 and the area of the shadow segment 140, then the quality score of the projected shadow 144 may be higher, and in this case may be equal to 0.2. Specific examples of cloud-to-shadow vectors can be seen as A1 and A2 in FIG. 6.

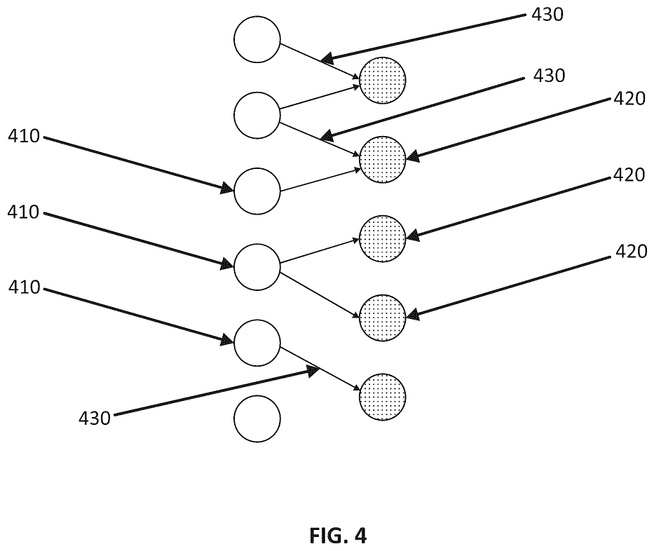

FIG. 4 is an illustration of the input to traditional maximum bipartite graph matching. Maximum bipartite graph matching is a mathematical tool that studies pairwise relationships between two different types of targets where no two links or edges share an endpoint. Maximum bipartite matching is the matching of a maximum number of edges or links between nodes, where if any edge is added, the added edge no longer matches any pair of nodes. Although this type of matching is referred to as maximum matching, there can be more than one maximum matching solutions for a given set of nodes. In FIG. 4, the two different types of vertices, or nodes, 410 and 420, represent clouds and cloud shadows, respectively. The links 430, also referred to as edges, match corresponding pairs of clouds 410 and shadows 420. However, maximum bipartite matching typically matches each input element, e.g., a cloud, to a single output element, e.g., a cloud shadow. The challenge to overcome in examples of the disclosure include finding the best set of edges or links 430 that match one or more clouds 410 to corresponding one or more cloud shadows 420 subject to geometric constraints, e.g., derived from viewing and illumination angles.

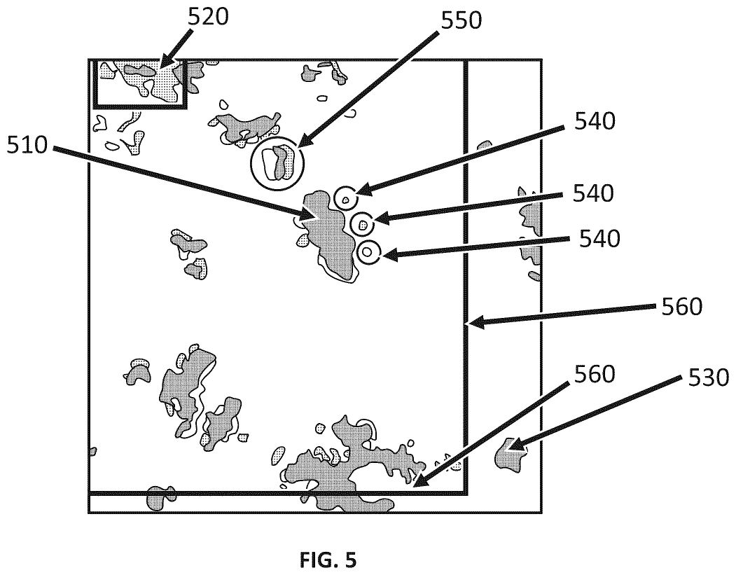

FIG. 5 is an illustration of a cloud matching result, in accordance with various examples of the disclosure. FIG. 5 illustrates various results of cloud and shadow matching. For example, a darker area or segment 510 indicates an agreement between a shadow and a corresponding cloud. Light areas or segments 520 indicate potential false negatives in the shadow mask, e.g., a cloud that does not have a corresponding shadow. Areas or segments 530 indicate potential false positives, e.g., a shadow which does not have a corresponding cloud. In examples, there may be inconsistencies between clouds and shadows, as designated by 540, which may include false positive and false negative pairs. FIG. 5 also includes areas of mismatch where cloud and shadow masks are inconsistent. Areas or segments 550 designates cloud and shadow pairings where the boundaries of each of the cloud and the shadow are close but do not completely agree. Such a phenomenon may occur due to the three-dimensional nature of clouds and a large variance in cloud altitudes. The lines 560 reflect the presumed displacement of the image of the clouds relative to the image of the shadows. Areas or segments 530 correspond to potential false positive shadow locations, e.g., a shadow which does not have a corresponding cloud. However, while potential false positives, the lack of observed corresponding clouds is unsurprising for areas 530 as these areas are outside the region (bounded by the line 560) where corresponding clouds would be expected to be outside the field of view of the image. Accordingly, by merely visualizing FIG. 5, it may be possible to determine errors in the cloud and shadow masks.

FIG. 6 is an illustration of refining mask results from geometric clues, in accordance with various examples of the disclosure. Because classical maximum bipartite graph matching typically includes one-to-one matching, simply applying this model to cloud and shadows segments in a satellite or GIS image may be ineffective because there may be one-to-many correspondences between cloud and shadows. For example, a single cloud may have several corresponding shadows, or several clouds may have a same shadow that may be, e.g., a combination of each cloud's individual shadow. This may be due, e.g., to the fact that a cloud may have a heterogeneous opacity or density, and that the resulting shadow of a single cloud may seem to have more than one corresponding shadow portions, so that the resulting GIS image may thus appear to show more than one shadow for the same cloud. Accordingly, the classical maximum bipartite graph matching technique discussed above with respect to FIG. 4 may be advantageously refined to account for this eventuality. For example, in FIG. 6, clouds 620 and cloud shadows 610 are grouped in various clusters 630, each cluster 630 including shadows 610 and clouds 620 that may correspond to each other. The clusters 630 are referred to herein as interconnected clusters because they may include a plurality of clouds 620 that correspond, or are connected, non-exclusively to a plurality of shadows 610. In FIG. 6, interconnected cluster “A” has clouds 3, 4, and 5 connected to shadows 1 and 2, which means that any one of clouds 3, 4, and 5 may have a corresponding shadow in any one or more of shadows 1 and 2. More specifically, shadow 2 appears to match to clouds 4 and 5, and shadow 1 appears to match only to cloud 3.

FIG. 6 illustrates clusters that do not necessarily need more than one cloud or shadow. In cluster “B,” shadow 6 appears to match to cloud 7, in cluster C, shadow 10 appears to match to cloud 11. FIG. 6 also illustrates clouds or shadows without matches. Shadow 12 does not appear to match to any cloud. Given the cloud-to-shadow direction 640, shadow 12 cannot correspond to any cloud segments and may be marked as a possible false positive. On the other hand, tracing a probable distance along the reversed cloud-to-shadow vector would predict a possible origin cloud to be off the image. In this case, the segment may be marked as a true positive shadow. For example, no clouds can be found in the reverse direction of the cloud-to-shadow direction from shadow 12. FIG. 6 also illustrates clouds 8 and 9 which have no matching shadows. For example, shadow 1 is outside of a plausible distance away from cloud 8 or 9, and shadow 1 also is far away from the cloud-to-shadow vector 640 for clouds 8 or 9. The direction or vector 640 corresponds to the cloud-to-shadow vector 150 discussed above with respect to FIG. 3. Arrows a1 and a2 indicate possible cloud-to-shadow vectors for clouds 5 and 11 respectively. Clustering is accomplished with a Depth-First search that will be further described below.

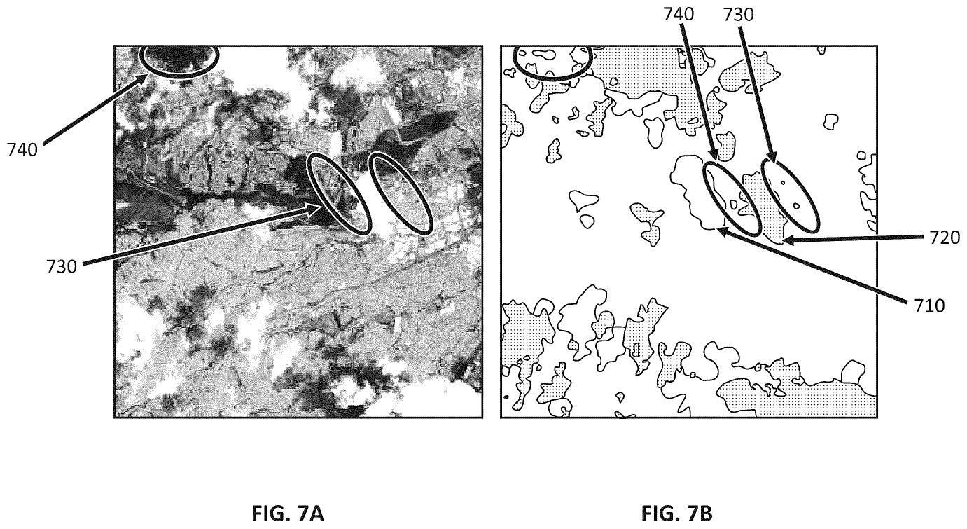

FIGS. 7A and 7B are illustrations of cloud shadow segmentation, in accordance with various examples of the disclosure. Specifically, FIG. 7A is a GIS image taken via, e.g., satellite or high-altitude aircraft, and the circled areas 730 and 740 indicate errors in the shadow mask of the initial cloud segmentation, where there is little correspondence between a cloud and the purported shadow thereof. In contrast, the cloud segment 710 shows a good match to the shadow segment 720.

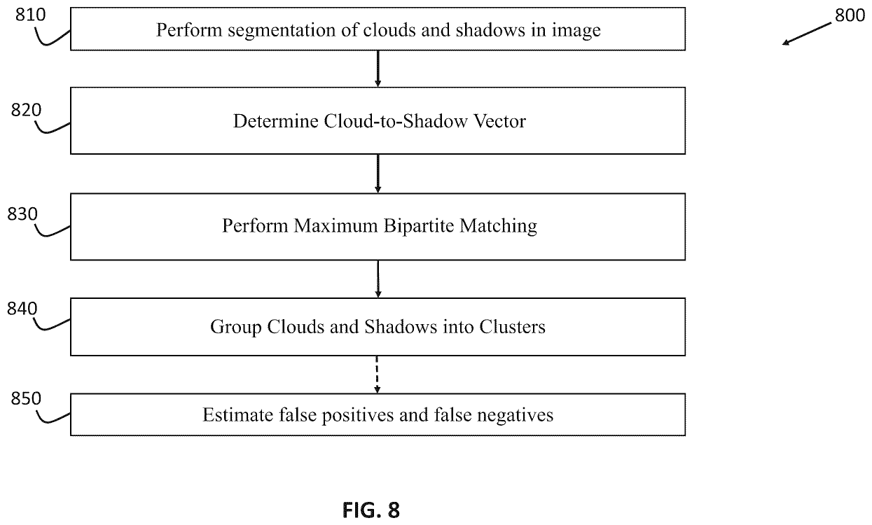

FIG. 8 is a flowchart illustrating a method for cloud and shadow matching for a high-altitude image of a portion of earth, in accordance with various examples of the disclosure. In FIG. 8, the method 800 starts with operation 810, which includes performing segmentation of clouds and shadows in the high-altitude image such as, e.g., a GIS image or a satellite image. The segmentation performed during operation 810 results in the generation of, e.g., one or more cloud masks or mask layers, and one or more cloud shadow masks. The cloud masks and cloud shadow masks delimit pixels on the GIS image that correspond to the cloud(s) and the cloud shadow(s) respectively. Operation 810 may also include numbering connected groups of pixels using standard connected components algorithm to get labels of segments as can be seen, e.g., in FIG. 6. With reference to FIG. 1B discussed above, a cloud mask is designated as 130, and a shadow mask is designated as 140.

Operation 820 includes determining a cloud-to-shadow vector or direction. With reference to FIG. 3, the arrow 150 indicating the cloud-to-shadow vector. The cloud-to-shadow direction may be based on a number of factors such as satellite azimuth and elevation and sun azimuth and elevation. Plausible cloud altitudes may be considered to compute the probable minimum and maximum distance between a cloud and its shadow along its cloud-to-shadow direction or vector.

Operation 830 includes performing standard maximum bipartite matching to determine a correspondence between at least one cloud and at least one shadow. As a result of operation 830, one or more cloud-shadow matches may be determined, where each cloud segment in the list is matched to a single shadow segment. In an example, no two cloud segments are matched to the same shadow segment. Also during operation 830, adjacency matrices may be created, and the adjacency matrices include cloud-shadow correspondences with quality scores for each cloud with a range of distances along the cloud-to-shadow vector. In an example, determining the adjacency matrix during operation 830 may be performed by, for each possible pair of cloud segment and shadow segment, sweeping through the range of probable distances along the cloud-to-shadow vector, with each distance extrapolating the segment of the cloud along the cloud-to-shadow vector, comparing the overlap between the extrapolated segment of the cloud and the shadow segment, and determining a score for the cloud-shadow-distance tuple based on the overlap. In an example, the score may be indicative of the number of overlapping pixels, e.g., a high enough score may lead to the conclusion that the distance along the cloud-to- shadow vector is accurate. Comparing the extrapolated segment of the cloud to the shadow segment may be achieved by performing an intersection over union calculation, which may be understood as an evaluation technique in object detection and image segmentation. Comparing the extrapolated segment of the shadow segment may be performed by determining a percentage overlap between the segment of the cloud and the segment of the shadow. As a result, the determined score may be, e.g., proportional to the percentage overlap.

For example, maximum bipartite matching may be performed by establishing the adjacency matrix as discussed above, and running an algorithm such as, e.g., the Kuhn-Munkres algorithm. As a result of maximum bipartite matching, the most likely altitude of the cloud for each resulting cloud-shadow pair may be determined. For example, the distance along the cloud- to-shadow vector identified by maximum bipartite matching may be used along with a number of factors such as satellite azimuth and elevation, and sun azimuth and elevation, to determine the 3D altitude of the cloud when it is imaged. A statistical distribution may be fit for the set of elevations from the resulting cloud-shadow pairs. For example, a Gaussian distribution may be fit. In another example, a Gaussian mixture model, or other model, may be used. With cloud altitude distribution determined, the quality scores in the adjacency matrix may be updated with the probability of each distance along the cloud-to-shadow vector. For example, the quality score may be updated by multiplying the previous quality score by the probability of that distance along the cloud-to-shadow vector.

In an example, performing maximum bipartite matching includes establishing a plurality of possible shadow locations for the at least one cloud, determining an adjacency matrix for quality scores of at least one cloud-shadow pair and a plurality of distances along the cloud- to-shadow vector, determining one or more desired cloud-shadow-distance tuples, determining a 3D cloud altitude for each cloud in the cloud-shadow pairs using a distance along the cloud-to- shadow vector, satellite azimuth and elevation, and sun azimuth and elevation, and determining a distribution of the 3D cloud altitudes. For example, an adjacency matrix value may be determined for each cloud-shadow pair. In another example, the maximum bipartite matching may be performed on the adjacency matrix to determine the best cloud-shadow-distance tuples.

In an example, determining the adjacency matrix for quality scores of at least one cloud-shadow pair and the plurality of distances along the cloud-to-shadow vector includes initializing a 3D matrix having dimensions including a number of cloud segments, a number of shadow segments, and a number of distances along the cloud-to-shadow vector, for each pair of cloud segment and shadow segment, determining a shape and area of the at least one cloud, for each distance of the plurality of distances along the cloud-to-shadow vector, extrapolating the determined shape and area of the at least one cloud to the distance along the cloud-to-shadow vector to generate an extrapolated cloud segment, comparing the extrapolated cloud segment to the shadow segment, and determining a quality score for the extrapolated cloud segment, shadow segment, and distance along the cloud-to-shadow vector tuple based on the comparison.

Operation 840 includes grouping the clouds and cloud shadows into clusters, as illustrated in FIG. 6. The clusters may be defined during operation 840 by creating a new sparse symmetric adjacency matrix with rows and columns each representing cloud and shadow segments, and weights being the quality score of the cloud-shadow match found with maximum bipartite matching or zero if the pair is unmatched. Operation 840 may further include running a Depth-First search on the adjacency matrix to generate clusters. Operation 840 may also include a final calculation of the altitude of every cloud cluster. This may be done by, for each cloud cluster, extrapolating the area and shape of the cloud cluster for all possible distances along the cloud-to-shadow vector, calculating the quality score of the extrapolated cloud cluster and the matching shadow cluster, choosing the distance that maximizes or improves the quality, and calculating the altitude of the cloud based on a number of factors such as satellite azimuth and elevation and sun azimuth and elevation. Grouping at least one cloud and at least one shadow into the cluster may include defining interconnected shadows and clouds, where either a single cloud is connected to a single shadow, a single cloud is connected to a plurality of shadows, a single shadow is connected to a plurality of clouds, or a plurality of clouds are simultaneously or contemporaneously connected to a plurality of shadows.

In an example, grouping at least cloud and at least one shadow into a cluster includes creating a sparse symmetric adjacency matrix, running a Depth-First Search on the adjacency matrix, and calculating a 3D cloud altitude of every cloud cluster based on the running of the Depth-First Search. For example, creating the sparse symmetric adjacency matrix includes creating a square matrix of zeros. If there are N clouds and M shadows, the matrix will be of size (N+M+1)-by-(N+M+1). Index 0 will represent the collection of all segments. Indices 1 to N will be used for the cloud segments. Indices N+1 to N+M will be used for the shadow segments. For each cloud-shadow correspondence from maximum bipartite matching having cloud index i and shadow index j, replace the entry at row i and column j in the sparse symmetric adjacency matrix with the quality score of the cloud-shadow correspondence. In an example, running the Depth- First Search includes running the Depth-First Search on a graph represented by the sparse symmetric adjacency matrix, and identifying each list of connected indices as a cluster of clouds and a cluster of shadows.

In an example, calculating the 3D cloud altitude of every cloud cluster includes, for each cloud cluster, extrapolating an area and shape of the cloud cluster for a plurality of distances along the cloud-to-shadow vector to generate an extrapolated cloud segment, for each distance of the plurality of distances, calculating the quality score of the extrapolated cloud cluster and shadow segment, choosing a distance with a desired quality score, and calculating the altitude of the cloud cluster based on a number of factors including satellite azimuth and elevation, and sun azimuth and elevation.

Operation 850 includes estimating false positives and false negatives of the cloud and shadow matching based on the final determined matches. Unmatched clouds may result in possible false negatives in the shadow mask at probable distances from the cloud along the cloud-to-shadow vector. Unmatched shadows may result in possible false negatives in the cloud mask at probable distances from the shadow along the reversed cloud-to-shadow vector. Each cloud's shape and area can be extrapolated at a probable distance along the cloud-to-shadow vector and compared to the shadow mask to find false negatives in the shadow mask. Each shadow's shape and area can be extrapolated at a probable distance along the reversed cloud-to-shadow vector and compared to the cloud mask to find false negatives in the cloud mask. Probable distances are determined by the determined altitude of clouds when clusters are found or based on the estimated probability distribution when a segment does not have a matching counterpart. In various examples, estimating false positives and false negatives in the cloud and shadow segmentation include identifying possible false positive cloud pixels, identifying possible false positive shadow pixels, identifying possible false negative cloud pixels, and identifying possible false negative shadow pixels.

In an example, identifying possible false positive cloud pixels includes classifying unmatched and unclustered cloud segments as possible false positives, and, for clustered cloud segments, identifying one or more expected distances of a match along the cloud-to-shadow vector, reversing the cloud-to-shadow vector, extrapolating the area and shape of the shadow cluster at an expected distance along the reversed cloud-to-shadow vector, and classifying cloud pixels that do not match the extrapolated shadow pixels as possible false positive cloud pixels.

In another example, identifying possible false positive shadow pixels includes classifying unmatched and unclustered shadow segments as possible false positives, and, for clustered shadow segments, identifying one or more expected distances of a match along the cloud-to-shadow vector, extrapolating the area and shape of the cloud cluster at the distance along the cloud-to-shadow vector, and classifying shadow pixels that do not match the extrapolated cloud pixels as possible false positive shadow pixels.

In yet another example, identifying possible false negative cloud pixels includes identifying each shadow segment, reversing the cloud-to-shadow vector, identifying one or more expected distances of a match along the reversed cloud-to-shadow vector, extrapolating the arca and shape of the shadow cluster at an expected distance along the reversed cloud-to-shadow vector, and classifying unmarked pixels that do not match the extrapolated shadow pixels as possible false negative cloud pixels.

In a further example, identifying possible false negative shadow pixels includes identifying each cloud segment, identifying one or more expected distances of a match along the cloud-to-shadow vector, extrapolating the area and shape of the cloud cluster at the distance along the cloud-to-shadow vector, and classifying unmarked pixels that do not match the extrapolated cloud pixels as possible false negative cloud pixels.

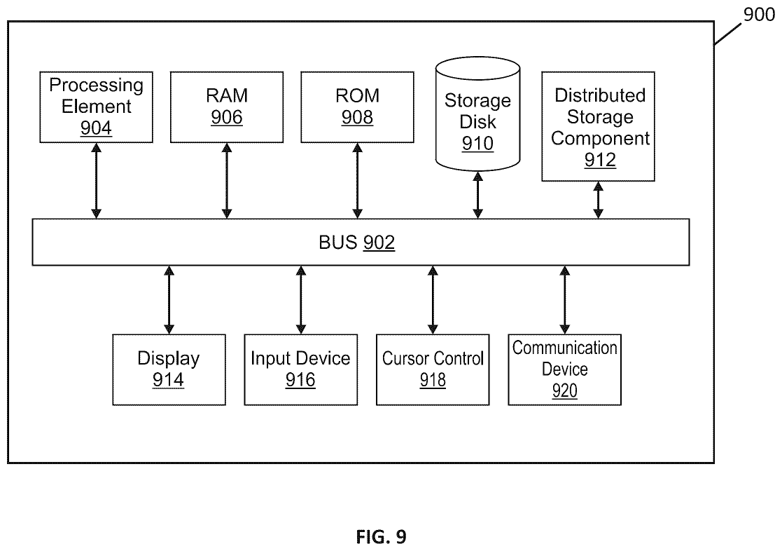

FIG. 9 depicts a block diagram of a computing device, according to various aspects. In the illustrated example, the computing device 900 may include a bus 902 or other communication mechanism of similar function for communicating information, and at least one processing element 904 (collectively referred to as processing element 904) coupled with bus 902 for processing information. As will be appreciated by those skilled in the art, the processing element 904 may include a plurality of processing elements or cores, which may be packaged as a single processor or in a distributed arrangement. Furthermore, a plurality of virtual processing elements 904 may be included in the computing device 900 to provide, e.g., the segmentation, the maximum bipartite matching, the comparison and the estimation operations or the method 800 illustrated and discussed above.

The computing device 900 may also include one or more volatile memory(ies) 906, which can for example include random access memory(ies) (RAM) or other dynamic memory component(s), coupled to one or more busses 902 for use by the at least one processing element 904. Computing device 900 may further include static, non-volatile memory(ies) 908, such as read only memory (ROM) or other static memory components, coupled to busses 902 for storing information and instructions for use by at least one processing element 904. A storage component 910, such as a storage disk or storage memory, may be provided for storing information and instructions for use by at least one processing element 904. As will be appreciated, the computing device 900 may include a distributed storage component 912, such as a networked disk or other storage resource available to the computing device 900.

The computing device 900 may be coupled to one or more displays 914 for displaying information to a user. Optional user input device(s) 916, such as a keyboard and/or touchscreen, may be coupled to Bus 902 for communicating information and command selections to at least one processing element 904. An optional cursor control or graphical input device 918, such as a mouse, a trackball or cursor direction keys for communicating graphical user interface information and command selections to at least one processing element. The computing device 900 may further include an input/output (I/O) component, such as a serial connection, digital connection, network connection, or other input/output component for allowing intercommunication with other computing components and the various operations of the method 800 illustrated and discussed above.

In various embodiments, computing device 900 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of the segmentation, the maximum bipartite matching, the comparison and the estimation operations or the method 800 illustrated and discussed above may be supported by operation of the distributed computing systems.

The computing device 900 may be operative to control various operations of the method 800 illustrated above through a communication device such as, e.g., communication device 920, and to handle data such as, e.g., encrypted and compressed data. In some examples, analysis results are provided by the computing device 900 in response to at least one processing element 904 executing instructions contained in memory 906 or 908 and performing operations on the received data items. Execution of instructions contained in memory 906 and/or 908 by at least one processing element 904 can render the method 800 operative to perform methods described herein.

The term “computer-readable medium” as used herein refers to any media that participates in providing instructions to the processing element 904 for execution. Such a medium may take many forms, including but not limited to, non-volatile media, volatile media, and transmission media. Non-volatile media includes, for example, optical or magnetic disks, such as disk storage 910. Volatile media includes dynamic memory, such as memory 906. Transmission media includes coaxial cables, copper wire, and fiber optics, including the wires that include bus 902.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 904 for execution. For example, the instructions may initially be carried on the magnetic disk of a remote computer. The remote computer can load the instructions into its dynamic memory and send the instructions over a telephone line using a modem. A modem local to computing device 900 can receive the data on the telephone line and use an infra-red transmitter to convert the data to an infra-red signal. An infra-red detector coupled to bus 902 can receive the data carried in the infra-red signal and place the data on bus 902. Bus 902 carries the data to memory 906, from which the processing element 904 retrieves and executes the instructions. The instructions received by memory 906 and/or memory 908 may optionally be stored on storage device 910 either before or after execution by the processing element 904.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method for performing cloud and shadow matching for a high-altitude image of a portion of earth, the method comprising:
performing segmentation of clouds and shadows in the image;
determining a cloud-to-shadow vector;
performing maximum bipartite matching to associate one shadow to at least one cloud;
grouping at least one cloud and at least one shadow into at least one cluster; and
estimating false positives and false negatives in the cloud and shadow segmentation.

2. The method of claim 1, wherein performing maximum bipartite matching comprises:
establishing a plurality of possible shadow locations for the at least one cloud;
determining an adjacency matrix for quality scores of at least one cloud-shadow pair and a plurality of distances along the cloud-to-shadow vector;
determining one or more desired cloud-shadow-distance tuples;
determining a 3D cloud altitude for each cloud in the cloud-shadow pairs using a distance along the cloud-to-shadow vector, satellite azimuth and elevation, and sun azimuth and elevation; and
determining a distribution of the 3D cloud altitudes.

3. The method of claim 2, wherein determining the adjacency matrix for quality scores of the at least one cloud-shadow pair and the plurality of distances along the cloud-to-shadow vector comprises:
initializing a 3D matrix having dimensions including a number of cloud segments, a number of shadow segments, and a number of distances along the cloud-to-shadow vector;
for each pair of cloud segment and shadow segment, determining a shape and area of the at least one cloud;
for each distance of the plurality of distances along the cloud-to-shadow vector, extrapolating the determined shape and area of the at least one cloud to the distance along the cloud-to-shadow vector to generate an extrapolated cloud segment;
comparing the extrapolated cloud segment to the shadow segment; and
determining a quality score for the extrapolated cloud segment, shadow segment, and distance along the cloud-to-shadow vector based on the comparison.

4. The method of claim 3, wherein comparing the extrapolated cloud segment to the shadow segment comprises performing an intersection over union process.

5.-6. (canceled)

7. The method of claim 1, wherein grouping the at least one cloud and the at least one shadow into the at least one cluster comprises:
creating a sparse symmetric adjacency matrix;
running a Depth-First Search on the adjacency matrix; and
calculating a 3D cloud altitude of every cloud cluster based on the running of the Depth-First Search.

8. The method of claim 7, wherein creating the sparse symmetric adjacency matrix comprises:
creating a square matrix of zeros with each dimension being a sum of a number of cloud segments (N), a number of shadow segments (M), and a unit representing a collection of all segments, wherein indices 1 to N represent the cloud segments and indices N+1 to N+M represent the shadow segments; and
for each cloud-shadow correspondence from maximum bipartite matching having cloud index i and shadow index j, replacing an entry at row i and column j in the sparse symmetric adjacency matrix with a quality score of the cloud-shadow correspondence.

9. The method of claim 7, wherein running the Depth-First Search comprises:
running the Depth-First Search on a graph represented by the sparse symmetric adjacency matrix; and
identifying each list of connected indices as a cluster of clouds and a cluster of shadows.

10. The method of claim 1, wherein grouping the at least one cloud and the at least one shadow into the at least one cluster comprises defining interconnected shadows and clouds, and wherein one of:
a single cloud is connected to a single shadow;
a single cloud is connected to a plurality of shadows;
a single shadow is connected to a plurality of clouds; and
a plurality of clouds are connected to a plurality of shadows.

11. The method of claim 2, wherein determining the 3D cloud altitude of every cloud cluster comprises, for each cloud cluster:
extrapolating an area and shape of the cloud cluster for a plurality of distances along the cloud-to-shadow vector to generate an extrapolated cloud segment;
for each distance of the plurality of distances, calculating a quality score of the extrapolated cloud segment and shadow segment;
choosing a distance with a desired quality score; and
calculating the 3D altitude of the cloud cluster based on a number of factors including satellite azimuth and elevation, and sun azimuth and elevation.

12. (canceled)

13. The method of claim 1, wherein identifying possible false positive cloud pixels comprises:
classifying unmatched and unclustered cloud segments as possible false positives; and
for clustered cloud segments:
identifying one or more expected distances of a match along the cloud-to-shadow vector;
reversing the cloud-to-shadow vector;
extrapolating an area and shape of a shadow cluster at an expected distance along the reversed cloud-to-shadow vector; and
classifying unmarked cloud pixels that do not match extrapolated shadow pixels as possible false positive cloud pixels.

14.-16. (canceled)

17. A cloud and shadow matching system for a high-altitude image of a portion of earth, the system comprising:
an updatable data repository;
a high-altitude image capture device; and
a computing device operatively coupled to the updatable data repository and to the high-altitude image capture device, the computing device comprising a processor and a memory;
the data repository storing instructions that, when executed by the processor, perform a set of operations comprising:
performing, via the processor, segmentation of clouds and shadows in the high- altitude image;
determining, via the processor, a cloud-to-shadow vector;
performing, via the processor, maximum bipartite matching to associate one shadow to at least one cloud;
grouping, via the processor, at least one cloud and at least one shadow into at least one cluster; and
estimating, via the processor, false positives and false negatives in the cloud and shadow segmentation.

18. The system of claim 17, wherein the set of operations comprises performing maximum bipartite matching by:
establishing a plurality of possible shadow locations for the at least one cloud;
determining an adjacency matrix for quality scores of at least one cloud-shadow pair and a plurality of distances along the cloud-to-shadow vector;
determining one or more desired cloud-shadow-distance tuples;
determining a 3D cloud altitude for each cloud in the cloud-shadow pairs using a distance along the cloud-to-shadow vector, satellite azimuth and elevation, and sun azimuth and elevation; and
determining a distribution of the 3D cloud altitudes.

19. The system of claim 18, wherein the set of operations comprises determining the adjacency matrix for quality scores of the at least one cloud-shadow pair and the plurality of distances along the cloud-to-shadow vector by:
initializing a 3D matrix having dimensions including a number of cloud segments, a number of shadow segments, and a number of distances along the cloud-to-shadow vector;
for each pair of cloud segment and shadow segment, determining a shape and area of the at least one cloud;
for each distance of the plurality of distances along the cloud-to-shadow vector, extrapolating the determined shape and area of the at least one cloud to the distance along the cloud-to-shadow vector to generate an extrapolated cloud segment;
comparing the extrapolated cloud segment to the shadow segment; and
determining a quality score for the extrapolated cloud segment, shadow segment, and distance along the cloud-to-shadow vector based on the comparison.

20. The system of claim 19, wherein the set of operations comprises comparing the extrapolated cloud segment to the shadow segment by performing an intersection over union process.

21.-22. (canceled)

23. The system of claim 17, wherein the set of operations comprises grouping the at least one cloud and the at least one shadow into the at least one cluster by:
creating a sparse symmetric adjacency matrix;
running a Depth-First Search on the adjacency matrix; and
calculating a 3D cloud altitude of every cloud cluster based on the running of the Depth-First Search.

24. The system of claim 23, wherein the set of operations comprises creating the sparse symmetric adjacency matrix by:
creating a square matrix of zeros with each dimension being a sum of a number of cloud segments (N), a number of shadow segments (M), and a unit representing a collection of all segments, wherein indices 1 to N represent the cloud segments and indices N+1 to N+M represent the shadow segments; and
for each cloud-shadow correspondence from maximum bipartite matching having cloud index i and shadow index j, replacing an entry at row i and column j in the sparse symmetric adjacency matrix with a quality score of the cloud-shadow correspondence.

25. The system of claim 23, wherein the set of operations comprises running the Depth-First Search by:
running the Depth-First Search on a graph represented by the sparse symmetric adjacency matrix; and
identifying each list of connected indices as a cluster of clouds and a cluster of shadows.

26. The system of claim 17, wherein the set of operations comprises grouping the at least cloud and the at least one shadow into the cluster by defining interconnected shadows and clouds, and wherein one of:
a single cloud is connected to a single shadow;
a single cloud is connected to a plurality of shadows;
a single shadow is connected to a plurality of clouds; and
a plurality of clouds are connected to a plurality of shadows.

27. The system of claim 18, wherein the set of operations comprises calculating the 3D cloud altitude of every cloud cluster by, for each cloud cluster:
extrapolating an area and shape of the cloud cluster for a plurality of distances along the cloud-to-shadow vector to generate an extrapolated cloud segment;
for each distance of the plurality of distances, calculating the quality score of the extrapolated cloud cluster and shadow segment;
choosing a distance with a desired quality score; and
calculating the altitude of the cloud cluster based on a number of factors including satellite azimuth and elevation, and sun azimuth and elevation.

28. (canceled)

29. The system of claim 17, the set of operations comprises identifying possible false positive cloud pixels by:
classifying unmatched and unclustered cloud segments as possible false positives; and
for clustered cloud segments:
identifying one or more expected distances of a match along the cloud-to-shadow vector;
reversing the cloud-to-shadow vector;
extrapolating an area and shape of a shadow cluster at an expected distance along the reversed cloud-to-shadow vector; and
classifying unmarked cloud pixels that do not match extrapolated shadow pixels as possible false positive cloud pixels.

30.-34. (canceled)
